(19) United States
(12) Patent Application Publication
(10) Pub. No.: US 2015/0354530 A1
(43) Pub. Date: Dec. 10, 2015

(54) MULTIPLE AIRFOIL WIND TURBINE BLADE ASSEMBLY

(71) Applicant: DISTRIBUTED THERMAL SYSTEMS LTD., Oakville (CA)

(72) Inventor: Howard Harrison, Mississauga (CA)

(21) Appl. No.: 14/761,556

(22) PCT Filed: Jan. 22, 2014
(86) PCT No.: PCT/CA2014/050046

§ 371 Date: Jul. 16, 2015

Related U.S. Application Data
(60) Provisional application No. 61/755,412, filed on Jan. 22, 2013.
(60) Provisional application No. 61/760,152, filed on Feb. 3, 2013.

(51) Int. Cl. F03D 1/02; F03D 1/00; F03D 1/06

(52) U.S. Cl. CPC F03D 1/025; F03D 1/0675; F03D 1/001

(57) ABSTRACT

A wind turbine blade assembly for a wind turbine having a root portion proximal to a hub of said wind turbine and a tip portion distal to said hub, comprising a primary airfoil having a primary leading edge and a secondary airfoil having a secondary leading edge wherein there is an aerodynamic gap between said primary airfoil and said secondary airfoil, with said primary airfoil configured to be located upwind of said secondary airfoil when assembled on the wind turbine.

### CROSS-REFERENCE TO RELATED APPLICATION

This application claims the benefit of and priority to U.S. Provisional Patent Application Nos. 61/755,412 and 61/760,152 filed Jan. 22, 2013 and Feb. 3, 2013.

The content of the above patent applications are hereby expressly incorporated by reference into the detailed description hereof.

### BACKGROUND OF THE INVENTION

Wind turbines have become an acceptable source of “green” electrical energy; however current designs have a few drawbacks that are preventing more widespread use. These include high cost, large size, which some consider unsightly, and noise. At the root of these problems is a less than ideal conversion of the wind's kinetic energy to the power produced by the turbine blades. A more efficient conversion is desirable since wind turbines could then produce more electrical power while blade length remained the same, or conversely, shorter blades could produce the same amount of electrical power from the wind, resulting in less expensive turbines, lower blade tip speeds and reduced noise. Further, a turbine with a variable aerodynamic response to the wind could be controlled to generate power more efficiently across a wider range of wind and load conditions.

U.S. Pat. No. 7,347,660 describes an improved type of Vertical Axis Wind Turbine (VAWT). U.S. Pat. No. 7,344,360 focuses on blade design for a single rotor Horizontal Axis Wind Turbine (HAWT) and claims blades with variable in plane sweep. U.S. Pat. No. 7,335,128 describes an improved transmission design for a HAWT. U.S. Pat. No. 7,331,761 describes an improved pitch bearing for HAWT blades. U.S. Pat. No. 7,293,959 describes a lift regulating means for independent blades on a HAWT rotor.

U.S. Pat. No. 8,564,154 dated Oct. 22, 2013, filed by Bahari, et al, discloses multiple rotors implemented as cascaded wind turbines with diffusers.

U.S. Pat. No. 8,197,179 dated Jan. 12, 2012, filed by Selsam discloses multiples rotors attached to an extended shaft which is supported at multiple points and remains stationary as the wind direction changes.

U.S. Pat. No. 8,002,526 dated Aug. 23, 2011, filed by Vettese, et al, discloses a rotor drum comprising a plurality of rotors to keep the rotors in a predetermined spaced apart relationship, so that all blades are offset to each other and balanced circumferentially.

Though multiple rotors have been taught, to the inventor's knowledge none have contemplated mounting multiple rotors coaxially with variable relative positions, to control the torque characteristics of the combined blades. Further none have contemplated the use of multiple airfoils on the same blade, separated by an aerodynamic gap, to provide substantially all of the aerodynamic benefits of multiple rotors on the same shaft. U.S. Pat. No. 7,299,627 addresses the destructive impact that the wind shadow of an upstream rotor has on a downstream rotor, in a wind farm installation, but does not anticipate the constructive benefits of mounting an upstream rotor and a downstream rotor on the same shaft. U.S. Pat. No. 6,713,893 discloses a first rotor and a second rotor, on different shafts, each on a different axis, and a combined generator to generate electrical energy when the field rotors rotate relative to each other. U.S. Pat. No. 6,504,260 teaches two counter-rotating rotors, each connected to a separate shaft and hub, each on a different axis, with both connected to a common generator system that allows for improved load control. U.S. Pat. No. 6,278,197 teaches two counter-rotating rotors, mounted at opposite ends of the generator, coaxially on an inner and an outer shaft, such that the wind induced counter-rotation of the two shafts creates electrical energy due to the generator components mounted there between.

### BRIEF DESCRIPTION OF DRAWINGS

FIG. 1 is a somewhat schematic front view of a prior art wind turbine configured with a single rotor having three blades at 120° intervals.

FIG. 2 is a somewhat schematic front view of a wind turbine configured with two coaxial rotors each having three blades at 120° intervals.

FIG. 3 is a somewhat schematic front view of a wind turbine configured with a single rotor having three blades each having a primary and secondary airfoil.

FIG. 4 is a somewhat schematic side view of a wind turbine configured with a single rotor having three blades each having a primary and secondary airfoil.

FIG. 5 is a somewhat schematic side view of a wind turbine configured with a single rotor having three blades each having a primary and secondary airfoil, wherein the blades are configured for retrofitting to an existing turbine.

FIG. 6 is a somewhat schematic front view of the wind turbine of FIG. 5.

FIG. 7 is a somewhat schematic front view of a further embodiment of the present invention—a wind turbine configured with a single rotor having three blades, each having three sections, with the midsection having a primary and secondary airfoil.

FIG. 8 is a somewhat schematic, cutaway, front view of a further embodiment of the invention—a wind turbine configured with a single rotor having three blades each having a primary and secondary airfoil, wherein the blades are adjustable in relation to one another. FIG. 8A is a somewhat schematic cross section of FIG. 8 at A-A.

### DETAILED DESCRIPTION

Multistage wind turbines with controllable aerodynamics and multiple airfoil turbine blades, are disclosed in U.S. Provisional Patents 61/755,412, entitled “Multistage Wind Turbine with Controllable Aerodynamics”, filed Jan. 22, 2013, and 61/760,152, entitled “Multistage Wind Turbine Blade for Retrofit Installations”, filed Feb. 3, 2013, by the same inventor, to which this application claims priority (both herewith also incorporated by reference). The present invention is a multiple airfoil turbine blade which can be used to retrofit to replace the single airfoil, OEM (Original Equipment Manufacturer) blades of traditional wind turbines with the multiple airfoil blades as disclosed herein. Such a retrofit provides improved performance of the wind turbine, as characterised by increased energy production and profitability, and/or decreased noise. Of course, as would be readily apparent, wind turbines can be made and sold with multiple airfoil blades at time of initial installation.

A typical, conventional Horizontal Axis Wind Turbine (HAWT) may be configured with a single three blade rotor. The corresponding wind turbine of the present invention is also configured with a single three blade rotor, with each blade having, along at least part of its length, at least two airfoils. The relationship between the two airfoils can be described using three basic parameters: axial displacement between the leading edges of the two airfoils; rotational displacement between the leading edges of the two airfoils, and differential pitch. Axial displacement may be defined as the distance between the leading edges of adjacent primary (upwind) and secondary (downwind) airfoils of a blade, as measured along the turbine shaft. Rotational displacement may be defined as the number of degrees or distance by which a secondary airfoil leads an adjacent primary airfoil in the direction of rotation. Differential pitch may be defined as the degree to which the angle of incidence of a secondary airfoil exceeds that of an adjacent primary airfoil. The primary and secondary airfoils may be of the same or different composition and/or geometry, to produce the desired combined aerodynamic and acoustic qualities. Further, the airfoils may have different rake angles such that at a particular non-zero angular displacement, or difference in azimuth angles, there is a more consistent local rotational displacement between the leading edges of the airfoils, and along the length of the airfoils, with local rotational displacement being the physical distance by which the leading edge of a secondary airfoil leads an adjacent leading edge of a primary airfoil, in the direction of rotation, at any point along the blade radius.

The present inventor has found that the multiple airfoil wind turbine rotor blades, when configured appropriately, create more lift and generate more power than a single airfoil or solid blade, from the same wind speed.

It should be noted that in a multiple airfoil blade configuration the rotational displacement will vary along the length of the airfoils for all but the zero angular displacement settings (which typically results in zero rotational displacement along the entire length of the blades). If constant rotational displacement is desired, the rake angle and angular displacement can be adjusted such that the rotational displacement becomes constant along the entire airfoil length, at a non-zero angular displacement. This may be advantageous and may provide excellent performance from the blade.

The structural integrity of a multiple airfoil blade may be improved by adding struts between the airfoils at the blade tips, and at various locations along the length of the airfoils. Such struts may be adjustable, in certain configurations, and thus provide both improved structural integrity and a way of modifying the axial or rotational displacement or the differential pitch of the airfoils relative to one another. These struts would create a “box-like” blade structure that would allow the individual blades to be constructed with less rigidity, hence less mass. The adjustable struts may be configured to provide this additional rigidity while still allowing for the adjustment of the three primary multi-stage wind turbine parameters; axial displacement, rotational displacement, and differential pitch.

In certain embodiments, the adjustable strut at the blade tips may also be configured to have further functional purposes, for example, to act as a winglet, to reduce vortex effects and induced drag, as a partial nozzle, to produce a local acceleration of the airflow, and/or with acoustic features to reduce turbine noise.

Further, in certain embodiments, the multiple airfoil design may only exist along a portion of the blade, forming a two-section blade. For example, the outer portion or section of a multiple airfoil turbine blade of the present invention may be configured with a single airfoil structure to optimize the performance and structural benefits of the design. The outer single, or mono airfoil section may be more favourably adapted to the higher apparent wind velocities, smaller angles of attack, and lower lift and drag requirements in the blade tip area, while the inner, dual airfoil section of the blade may be more favourably adapted to the lower apparent wind velocities, larger angles of attack, and higher lift and drag requirements in the middle and root areas of the wind turbine blade.

The inner dual airfoil section of such a two-section blade would retain all of the structural benefits of the inherent “box like” structure, as previously discussed. Hence the overall mass of a two-section blade as heredescribed may be designed to be very close to that of an equivalent length “traditional” or “mono” blade structure as commonly seen on most wind turbines today. Thus, a multiple airfoil blade of the above design, either with an outer monofoil section or not, may be used to replace a traditional OEM wind turbine blade with minimal modifications to the existing hub, bearings, and other major mechanical turbine components.

Analogously to the two-section blade described above, in certain embodiments, the root of a multiple airfoil blade may also merge into a single root structure with a mounting flange that matches that of the OEM wind turbine blade that it is designed to replace. This configuration may be more easily adapted for OEM blade retrofits, where a multiple airfoil blade may be attached to the existing hub and utilize the existing control mechanisms. For example the existing pitch control mechanism would simply rotate the entire multiple airfoil blade with respect to the wind, simultaneously changing the angle of attack for both the inner, dual airfoil portion of the blade and the outer, mono airfoil portion of the blade, replicating the pitch control of the original OEM blades. A conventional wind turbine retrofitted with dual airfoil, dual portion blades in this manner would operate more efficiently; thereby providing better performance, increased energy production and enhanced profitability.

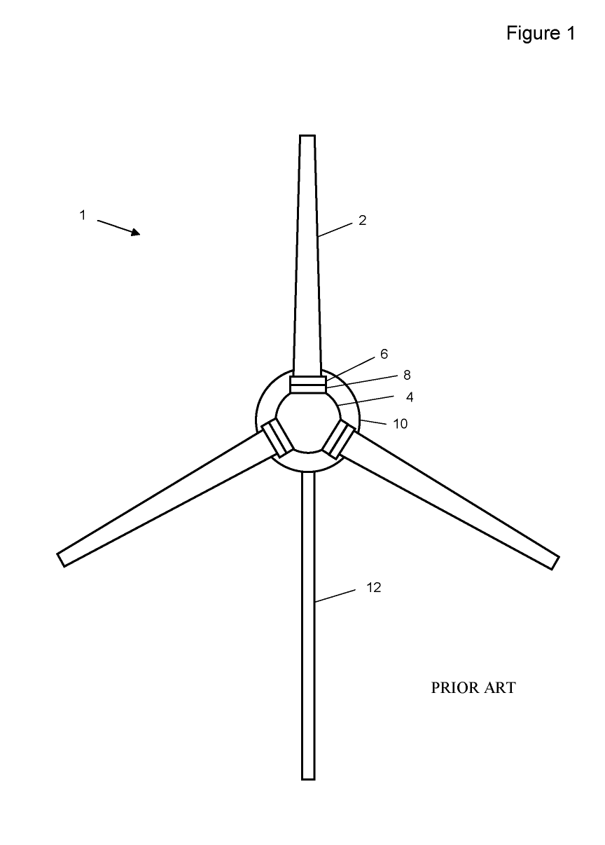

FIG. 1 presents a somewhat schematic front view of conventional prior art wind turbine 1, configured with a single rotor having three blades at 120° intervals. Conventional blade 2 may be fastened to conventional hub 4 by a number of bolts located around the perimeters of conventional root flange 6 and conventional hub flange 8. Conventional root flange 6 may be configured as an integral part of conventional blade 2, forming a rigid blade and root structure. Further, conventional hub flange 8 may be rotatingly attached to conventional hub 4, allowing the pitch angle of conventional blade 2 to be adjusted with respect to the wind, thereby controlling conventional wind turbine 1. Other major components of conventional wind turbine 1 include nacelle 10, housing the generator (not shown), and mast 12.

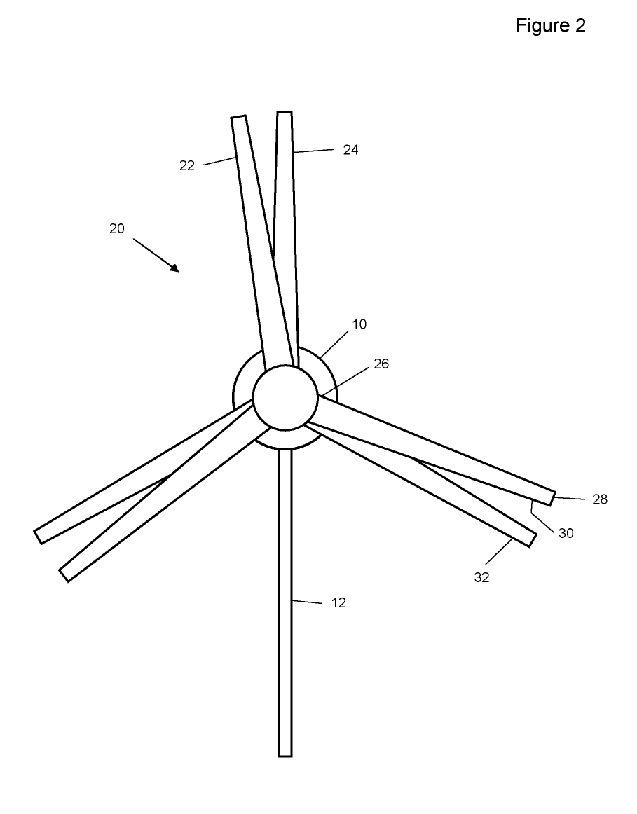

FIG. 2 presents a somewhat schematic front view of a wind turbine 20, configured with two rotors, each having three blades at 120° intervals. The combined aerodynamics of upwind or primary rotor 22 and downwind or secondary rotor 24 may be modified by adjusting the relative positions of primary rotor 22 and secondary rotor 24, as previously disclosed by the same inventor in U.S. Provisional Patent 61/755,412, entitled “Multistage Wind Turbine with Controllable Aerodynamics”, filed Jan. 22, 2013, hereby incorporated by reference. Once adjusted correctly, primary rotor 22 and secondary rotor 24 perform in locked rotation until the next aerodynamic adjustment is required. Multistage wind turbine 20 may be configured with substantially the same nacelle 10 and mast 12, thereby providing an enhanced performance retrofit for the conventional rotor in FIG. 1.

In this configuration, the rotational displacement between primary rotor 22 and secondary rotor 24 may be defined as the physical distance between secondary leading edge 32 and primary leading edge 30, at any given similar point along the radius of the primary and secondary blades. It may be observed that the rotational displacement increases as that reference point is moved from blade root 26 to blade tip 28. Further, in many configurations the turbine blades are tapered, i.e. the chord (or width of the blade) at blade tip 26 is less than the chord at blade root 28. It follows that blade taper actually increases the rate at which the rotational displacement increases from blade root 26 to blade tip 28, when rotational displacement is normalized to chord length.

As a result the two rotor implementation of wind turbine 20 may be less desirable since it is known that there is a small range of optimal rotational displacement values, when normalized to the chord length. This may be addressed to some extent with two rotors having different rake angles and angular displacements, however, the presently described invention teaches that a consistent rotational displacement along the entire length of the blade may also be achieved with a single blade, dual airfoil system. The present invention also removes the need for a complex, coaxial, two rotor implementation, thereby simplifying the wind turbine substantially.

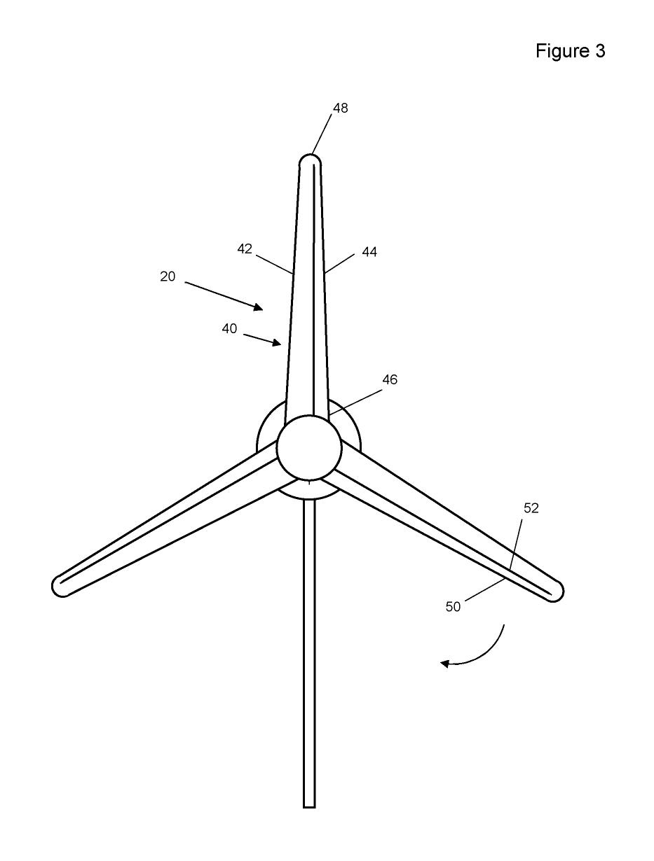

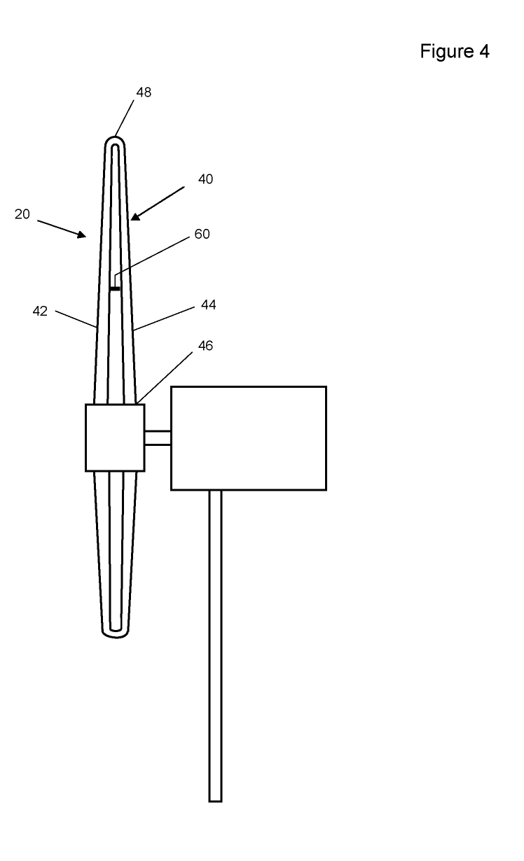

FIG. 3 presents a somewhat schematic front view of wind turbine 20 configured with three multiple airfoil blades 40. Multiple airfoil blade 40 is configured with a primary airfoil 42 and a secondary airfoil 44. In a preferred embodiment, and as shown, primary airfoil 42 and secondary airfoil 44 are separated by an axial displacement that is greater at multiple airfoil blade root 46 and lesser at multiple airfoil blade tip 48, as depicted in FIG. 4. Primary airfoil 42 and secondary airfoil 44 may have the same or different airfoil geometries.

In a preferred embodiment, and as illustrated in FIG. 3, the rotational displacement, or distance between primary airfoil leading edge 50 and secondary airfoil leading edge 52, is similar along the entire length of multiple airfoil blade 40. Further, the actual rotational displacement may be reduced at a rate that closely matches the taper rate on primary airfoil 42 and secondary airfoil 44, such that the normalized rotational displacement, i.e. when referenced to the chord length at any given blade radius, is reasonably consistent along the entire length of multiple airfoil blade 40. The consistent normalized rotational displacement, as illustrated, is approximately 0.5 chord or “0.50”; however the principles taught herein may be used to achieve any desired consistent normalized rotational displacement, or in fact to implement any intentional variations in rotational displacement as may enhance the overall performance of a wind turbine configured with multiple airfoil blades 40. We have found that a rotational displacement of −1.0 to +1.0 chord works well, preferably +0.3 to +1.0 chord, with a rotational displacement of +0.5 chord illustrated. We have also found that a configuration with an axial displacement of up to +1.0 chord between leading edges of the twin airfoils works quite well, preferably +0.5 to +1.0 chord, as does a differential pitch of between −6° and +6°, preferably between −3° and +3° with a differential pitch of 0° shown.

FIG. 4 presents a somewhat schematic side view of a wind turbine 20 configured with multiple airfoil blades 40. In a preferable embodiment, and as shown, primary airfoil 42 and secondary airfoil 44 are separated by an axial displacement that is greater at multistage blade root 46 and lesser at multiple airfoil blade tip 48, providing an aerodynamic gap between the airfoils that tapers towards multiple airfoil blade tip 48. Preferably, and as shown, the multiple airfoil blade 40 is also configured with an air gap taper that varies with the chord taper, providing a normalized gap that is reasonably consistent along the entire length of the blade. It would be evident to a person of skill in the art that the principles taught herein may be used to achieve any consistent normalized gap, or in fact to implement any intention variations in gap as may enhance the overall performance of a wind turbine configured with multiple airfoil blades 40.

As shown in a preferred embodiment, it is noted that the structural integrity of multiple airfoil blade 40 is greatly enhanced by the joining of primary airfoil 42 and secondary airfoil 44 at multiple airfoil blade root 46 and multiple airfoil blade tip 48, creating a type of “box wing”. The structural strength inherent in this design allows the mass of each airfoil to be greatly reduced, for example, to the extent that the combined mass of both airfoils will be very close to that of a conventional wind turbine blade of similar length and overall stiffness. The structural integrity of multiple airfoil blade 40 may be further enhanced by the addition of one more internal struts 60, which may be more suited to applications that require “stiff” blades as opposed to blades that are designed to intentionally flex in gusts and stronger winds. Multiple airfoil blade 40 may also be designed to intentionally flex in gusts and stronger winds, for example, by making one or both of the airfoils deliberately flexible and/or through the absence of internal struts 60.

Similarly to a conventional blade, the blade tip 48 of may also be configured with other features to improve the aerodynamic performance of multiple airfoil blade 40, nominally by reducing the drag, controlling the vortex, and/or to reduce the acoustic noise produced by multiple airfoil blade 40. These may include a narrower tip, a winglet, offset tips, and other aerodynamic features known to those familiar with the art.

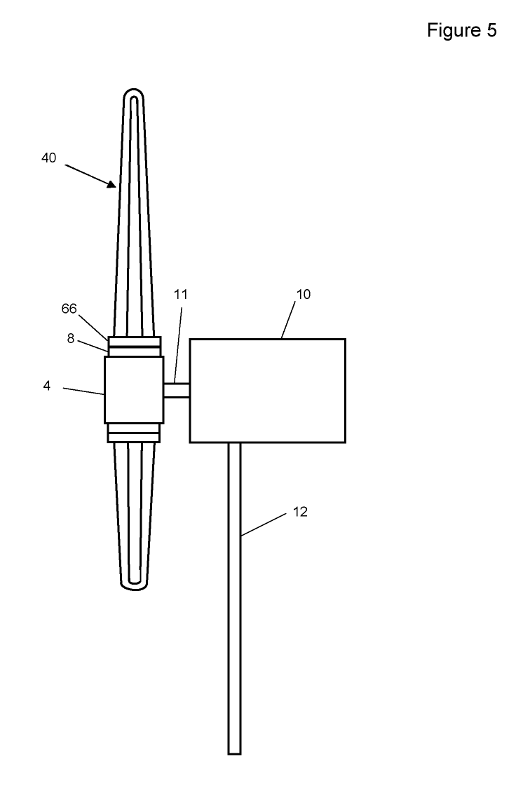

FIG. 5 presents a somewhat schematic side view of multiple airfoil blade 40 configured for retrofitting an existing wind turbine. In this case multiple airfoil blade 40 may be fastened to conventional hub 4 by a number of bolts located around the perimeters of multiple airfoil root flange 66 and conventional hub flange 8. Multiple airfoil root flange 66 may be configured as an integral part of multiple airfoil blade 40, forming a rigid blade and root structure. Further, conventional hub flange 8 may be rotatingly attached to conventional hub 4, allowing the pitch angle of multiple airfoil blade 40 to be adjusted with respect to the wind, thereby controlling the retrofitted wind turbine. It follows that controlling the new multiple airfoil blades is very similar to controlling the conventional wind turbine blades that they replace. Other major components of conventional wind turbine 1 remain substantially the same; including nacelle 10, housing the generator, main shaft 11, and mast 12 (reference FIG. 1).

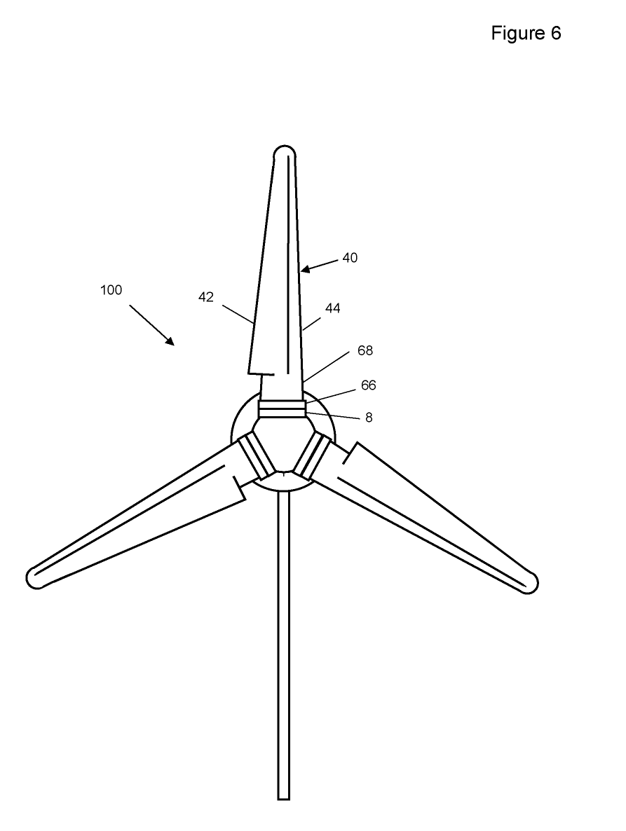

FIG. 6 presents a somewhat schematic front view of wind turbine with multiple airfoil retrofit blades 100. In a preferred embodiment, multiple airfoil root flange 66 is configured to interface directly with the existing conventional hub flange 8, inherently allowing the existing pitch control mechanism to control the new blades. Slight variations in other turbine characteristics such as yaw response, ideal tip speed ratios (TSR), etc. may be accommodated by upgrading the turbine control software.

In certain preferred embodiments, and as shown, multiple airfoil blade 40 is configured with adaptive root section 68, which (as shown) may be of a single airfoil design and which provides a smooth transition from the combined airfoil geometries and the diameter of multiple airfoil root flange 66, which in many cases may actually be less than the combined width of primary airfoil 42 and secondary airfoil 44 at the root. Adaptive root section 68 may be further designed to improve the structural integrity of the multiple airfoil blade while reducing and/or improving the distribution of its mass.

In certain preferred embodiments, multiple airfoil blade 40 is further optimized with intentional variations in gap, stagger and differential pitch along its length, for example to create virtual twist while simplifying the combined blade geometry, to maximize the overall torque, and so on. Similar approaches may also be used to equalize the lift on the two airfoils, allowing for reduced mass of the overall structure. In certain configurations, for example when using multiple airfoil blade 40 in new installations, it may also be possible to use additional control techniques to adjust and optimize the multiple airfoil blade while it is operating, for example by adjusting the differential pitch on all or part of one or both of the airfoils, or by incorporating controllable features to initiate stall.

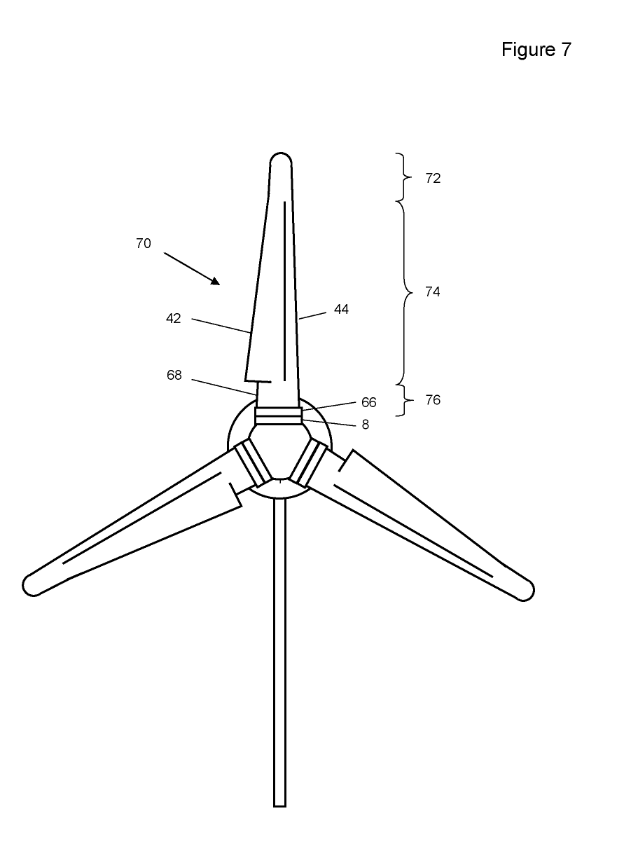

One such optimization technique is illustrated in FIG. 7, where it may be seen that optimized multistage blade 70 has been divided into three distinct regions; tip region 72, mid region 74 and root region 76. More or less regions may be selected for optimization purposes however the applicable principle taught herein remains the same, this being that each region may have a different aerodynamic design that leads to the overall optimization of the blade.

As shown, tip region 72 is configured with a traditional single or “mono” airfoil design. This mono airfoil may be an extension of secondary airfoil 44, in which case primary airfoil 42 would not extend into tip region 72, or it may be designed as an independent airfoil. In any case the mono airfoil is more favourably adapted to the higher apparent wind velocities, smaller angles of attack, and lower lift and drag requirements in tip region 72. A mono airfoil tip may also, in some configurations, provide improved acoustic characteristics relative to a twin airfoil tip, particularly at higher tip speed ratios. Further, a mono airfoil tip is typically a more suitable platform for the addition of winglets and other features designed to enhance vortex management and improve overall performance, and/or to reduce noise.

Mid region 74 may be configured with a multiple airfoil design, to increase overall performance through the appropriate optimization of axial displacement, rotational displacement and differential pitch, as described herein. As shown, however, mid region 74 is a multiple airfoil design, and root region 76, like tip region 72, is a mono airfoil design. The multiple airfoil configuration is typically more favourably adapted to the lower apparent wind velocities, larger angles of attack, and higher lift and drag requirements in mid region 74 (and optionally and not shown, root region 76). Further, a multiple airfoil configuration inherently performs better at higher angles of attack, hence it may be configured with a lower pitch angle than would normally be required for a mono airfoil section used in theses regions, thereby requiring less blade twist and simplifying the overall blade design.

In certain embodiments, a multiple airfoil configuration may provide reduced chord lengths and reduced blade thickness to chord ratios, while still providing the required aerodynamic performance and structural integrity. Note that the rigid box structure is retained by the mono airfoil structure interfaces at the top (i.e. with tip region 72, which is a mono blade) and bottom (i.e. with adaptive root section 68, which is also a mono foil) of the dual blade section. The rigidity may be further enhanced with internal struts and other features, if required, and as previously described. Other aero-structural optimization techniques will become evident as more is learned about the aerodynamics and structural characteristics of multiple airfoil blades.

An additional benefit of the optimized multiple airfoil blade design is that it may designed as a modular blade, to be assembled in the field, thereby facilitating the transportation process which has heretofore been a limiting factor in the maximum size of transportable wind turbine blades. Root region 76, including multiple airfoil root flange 66 and adaptive root section 68, and mid region 74 may be pre-manufactured as one sub-assembly, and tip region 72 may be pre-manufactured as a second sub-assembly, with the first and second sub-assemblies being adapted for final assembly in the field.

The subassemblies may be configured with mating flanges, alignment pins, or other features to ease the final assembly process while ensuring the structural integrity of a modular optimized multiple airfoil blade 70. Mating flanges, if used, may be similar to multiple airfoil root flange 66 but with a cross sectional profile that matches the airfoil at the module mating radius and smooth outer surfaces. In the case of alignment pins, a suitable composite bond may be formed in the field with a combined clamping, bonding agent applicator, and thermal control device. The clamping function may be designed to cooperate with the alignment pins to hold the two modules to a high level of alignment. The alignment may be further confirmed by supplementary alignment tools such as lasers. The bonding agent applicator function may be designed to apply the correct amount of bonding agent in the correct locations, and to retain that correct amount of bonding agent in place until the curing process is complete. The thermal control function may be designed to retain the module interface at working temperature until the clamp has been applied and the bonding agent is in place, then to apply heat to start the curing process, then to release heat and control the temperature of the bond until the exothermic curing process is complete. All three functions may be performed within a shroud attached to the back of the truck used to transport the larger module, with the truck bed providing the necessary rigid platform upon which to align and form the bond. Power may be provided by the tractor pulling the truck bed, or by an independent generator connected to the shroud.

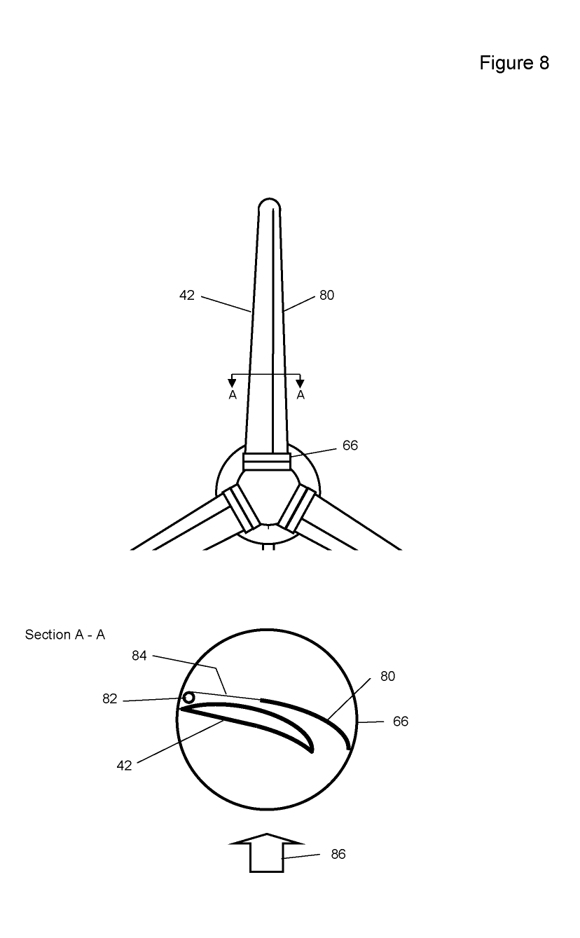

FIG. 8 illustrates an additional control technique, whereby the secondary airfoil is an adaptive airfoil 70 which may be adjusted with respect to primary airfoil 42. Secondary adaptive airfoil 70 may be configured as a fixed thin airfoil, or a flexible airfoil comprised of materials such as mylar sheets, metal sheets or even cloth. If flexible, adjustment of secondary adaptive airfoil 80 may be accomplished through airfoil winch 82, which may be mounted on multistage root flange 66. Airfoil winch 82 may be tightened or slackened, to shorten or lengthen the exposed length of tension line 84, respectively, thereby adjusting the shape of secondary adaptive airfoil 80.

Generally speaking, power may be increased by tightening airfoil winch 82 and, conversely, power may be decreased by slackening airfoil winch 82 until secondary adaptive airfoil 80 begins to “flap” or “luff” in the wind. Other adjustable configurations are possible, including the use of a flexible primary airfoil.

The optimized multiple airfoil wind turbine blade assembly of the present invention allows for many applications. Although reference is made to the embodiments listed above, it should be understood that these are only by way of example and to identify the preferred uses of the invention known to the inventor at this time. It is believed that the optimized multiple airfoil wind turbine blade assembly has many additional uses evident once one is familiar with the fundamental principles of the invention. These may include, for example, an adaption of the principles taught herein to allow for the modularization and field bonding of traditional single blades for wind turbines and other large composite structures.

The above noted examples and exemplifications of the invention are not meant to be limiting, and are merely examples of the invention embodied by the claims described below. All patents and applications described herein are hereby incorporated by reference.

1. A wind turbine blade assembly for a wind turbine, having, when assembled on said wind turbine, a root portion proximal to a hub of said wind turbine and a tip portion distal to said hub, said wind turbine blade assembly comprising:
a. a primary airfoil having a primary leading edge; and
b. a secondary airfoil having a secondary leading edge;
wherein there is an aerodynamic gap between said primary airfoil and said secondary airfoil, with said primary airfoil configured to be located upwind of said secondary airfoil when assembled on the wind turbine.

2. The wind turbine blade assembly of claim 1, wherein said primary airfoil and said secondary airfoil have the same airfoil geometry.

3. The wind turbine blade assembly of claim 1, wherein said primary airfoil and said secondary airfoil have different airfoil geometries.

4. The wind turbine blade assembly of any one of the preceding claims, wherein said primary airfoil and said secondary airfoil are structurally connected by struts extending through said aerodynamic gap.

5. The wind turbine blade assembly of claim 4 wherein said struts are located between the root of said wind turbine blade assembly and the tip of said wind turbine blade assembly.

6. The wind turbine blade assembly of any one of the preceding claims, wherein said primary airfoil and said secondary airfoil have chord lengths that are greater at the root portion than at the tip portion.

7. The wind turbine blade assembly of any one of the preceding claims, wherein said aerodynamic gap is greater at the root portion than at the tip portion.

8. The wind turbine blade assembly of any one of the preceding claims, wherein said aerodynamic gap is a constant portion of the chord length of said primary airfoil and said secondary airfoil, along the entire length of said primary airfoil and said secondary airfoil.

9. The wind turbine blade assembly of any one of the preceding claims, wherein said secondary leading edge is configured to have rotational displacement with respect to the primary leading edge.

10. The wind turbine blade assembly of claim 9 wherein said rotational displacement is a constant portion of a chord length of said primary airfoil and said secondary airfoil, over the entire length of said primary airfoil and said secondary airfoil.

11. The wind turbine blade assembly of claim 10 wherein the rotational displacement is between about −1.0 to about +1.0 chord, preferably between about +0.3 to +1.0 chord, more preferably about +0.5 chord.

12. The wind turbine blade assembly of any one of the preceding claims, wherein said primary airfoil and secondary airfoil have a differential pitch angle of between about −6 to +6 degrees, preferably between about −3 to +3 degrees.

13. The wind turbine blade assembly of any one of the preceding claims wherein said primary airfoil and said secondary airfoil are mounted on separate hubs.

14. The wind turbine blade assembly of any one of the preceding claims wherein said primary airfoil and said secondary airfoil are joined at the root portion and at the tip portion.

15. The wind turbine blade assembly of any one of the preceding claims, wherein the root portion comprises a flange configured to be matingly attached to a standard wind turbine hub.

16. The wind turbine blade assembly of claim 15, wherein the flange is configured to rotate with a standard wind turbine pitch control system when matingly attached.

17. The wind turbine blade assembly of any one of the preceding claims, further comprising a tip airfoil distal to said primary airfoil and said secondary airfoil, relative to the root portion.

18. The wind turbine blade assembly of claim 17, further comprising an airfoil interface connecting said tip airfoil to the primary airfoil and/or the secondary airfoil.

19. The wind turbine blade assembly of claim 17 or 18, wherein said tip airfoil is a single airfoil.

20. The wind turbine blade assembly of any one of claims 17-19, wherein said tip airfoil has a different differential pitch than said primary airfoil and/or said secondary airfoil.

21. The wind turbine blade assembly of any one of claims 17-20, wherein the tip airfoil comprises a winglet at its distal end.

22. The wind turbine blade assembly of any one of claims 18-21, wherein said primary airfoil and said secondary airfoil form a first sub-assembly, said tip airfoil forms second sub-assembly, and said first sub-assembly and said second sub-assembly may be later bonded or fastened at said airfoil interface.

23. The wind turbine blade assembly of claim 22, wherein said first sub-assembly and said second sub-assembly are aligned at said airfoil interface with locating pins.

24. The wind turbine blade assembly of claim 22, wherein said first sub-assembly and said second sub-assembly are bonded at a remote location.

25. The wind turbine blade assembly of claim 22, wherein said first sub-assembly and said second sub-assembly are bonded by a transportable bonding device, said bonding device providing clamping, bonding agent application, and thermally controlled curing.

26. A wind turbine blade assembly of any one of the preceding claims, wherein at least one of said primary airfoil and said secondary airfoil is a thin airfoil.

27. A wind turbine blade assembly of any one of the preceding claims, wherein at least one of said primary airfoil and said secondary airfoil is an adaptive airfoil such that the shape or angle of the adaptive airfoil can be modified while said blade assembly is assembled on said turbine.

28. The wind turbine blade assembly of claim 27 further comprising an airfoil winch capable of modifying the shape or angle of the adaptive airfoil.

29. The wind turbine blade assembly of claim 27 wherein the shape or angle of the adaptive airfoil can be modified relative to the shape or angle of an other airfoil on said blade assembly.

30. A wind turbine comprising at least one wind turbine blade assembly of any one of the preceding claims.

31. A wind turbine comprising three wind turbine blade assemblies of any one of claims 1-29, assembled on and extending from a hub of the wind turbine at about 120° from one another.
